(19) United States
(12) Patent Application Publication
(10) Pub. No.: US 2009/0150780 A1
(43) Pub. Date: Jun. 11, 2009

(54) Help utility functionality and architecture

(75) Inventors: Morris J. Young, Indianapolis, IN (US); Janette Elaine Allen, Indianapolis, IN (US); Schuyler Buck, Muncie, IN (US); Jeremy D. Anthony, Indianapolis, IN (US); Ryan Scott McKinney, Jamestown, IN (US)

Correspondence Address: BAKER & DANIELS LLP / ROCHE, 300 NORTH MERIDIAN STREET, SUITE 2700, INDIANAPOLIS, IN, 46204, US

(73) Assignees: Roche Diagnostics Operations, Inc., Indianapolis, IN (US); Software Engineering Professionals

(21) Appl. No.: 11/999,906

(22) Filed: Dec. 7, 2007

(51) Int. Cl. G06F 3/00

(52) U.S. Cl. 715/713

(57) ABSTRACT

A system and method is provided for displaying a first selectable indicia that, when selected, produces a document of first help information relating to a first topic. The system and method also displaying a second selectable indicia that, when selected, produces a document of second help information relating to a chapter that includes the first topic.

### FIELD OF THE INVENTION

The present disclosure relates to a method and system for managing health by facilitating the interpretation of data. More particularly, the disclosure relates a method and system for providing targeted help to users of a data interpretation program.

### BACKGROUND AND SUMMARY

Many fields of medical treatment and healthcare require monitoring of certain body functions, physical states and conditions, and patient behaviors. Thus, e.g., for patients suffering from diabetes, a regular check of the blood glucose level forms an essential part of the daily routine. The blood glucose level has to be determined quickly and reliably, often several times per day. Medical devices are used to facilitate the collection of medical information without unduly disturbing the lifestyle of the patient. A large number of medical devices for monitoring various body functions are commercially available. Also, medical treatment and healthcare may require monitoring of exercise, diet, meal times, stress, work schedules and other activities and behaviors.

To reduce the frequency of necessary visits to doctors, the idea of home care gained popularity over the recent years. Technological advancements in medicine led to the increased use of medical devices. Many of these medical devices, such as meters and medicine delivery devices, are able to collect and store measurements and other data for long periods of time. Other devices, such as computers, portable digital assistants (PDAs), and cell phones, have been adapted to medical uses by the development of software directed to the collection of healthcare data. These advancements led to the development of health management systems that enable collection and use of large numbers of variables and large amounts of healthcare data.

While systems were traditionally developed for use in healthcare facilities and health management organizations including insurance companies and governmental agencies (HCP systems), increased technological sophistication by the populous at large led to the increased use of health management systems by patients, care givers, and others (patient systems) in addition to increased use by HCP systems. U.S. Pat. No. 7,103,578 and U.S. Published Application No. 2004/0172284 disclose two such methods and systems. Many of these systems are able to transfer data between them. Patient healthcare data is often transferred from a patient system to an HCP system. HCP systems may transfer remarks and other data to patient systems or other HCP systems.

The disclosure relates to a method and system for providing instructions and help for healthcare and homecare systems. One embodiment of the system includes a computer readable medium, including instructions thereon. The instructions, when interpreted by a processor, cause the processor to perform the steps of: receiving medical data from a health management device; displaying a multi-level help tree, the help tree having help information relating to medical data processing functionality; the help tree segmenting the help information into a plurality of selectable chapters, each chapter including at least one displayable help page; displaying a first icon that, when selected, issues instructions to print the displayed help page; displaying a second icon that, when selected, issues instructions to print all help pages within the same chapter as the displayed page; and displaying a third icon that, when selected, issues instructions to print all available help pages.

In some embodiments, a computer readable medium including instructions thereon is provided. The instructions, when interpreted by a processor, cause the processor to perform the steps of: displaying a first icon that, when selected, issues instructions to produce a document including first help information relating to a displayed page; and displaying a second icon that, when selected, issues instructions to produce a document including second help information relating to a chapter that includes the displayed page.

In another embodiment, a computer readable medium including instructions thereon is provided. The instructions, when interpreted by a processor, cause the processor to perform the steps of: displaying a first selectable indicia that, when selected, issues instructions to produce a document including first help information relating to a first page; and displaying a second selectable indicia that, when selected, issues instructions to produce a document including second help information relating to a chapter that includes the first page.

In yet another embodiment of the method according to the invention, a computer readable medium including instructions thereon is provided. The instructions, when interpreted by a processor, cause the processor to perform the steps of: reading a plurality of files, each file pertaining to a topic and having organizational data and displayable data therein; assembling a hierarchical layout of the topics of the plurality of files according to the organizational data; and displaying the displayable data of at least one of the plurality of files.

### DESCRIPTION OF THE DRAWINGS

For more complete understanding of the present disclosure, reference is established to the following drawings in which:

FIG. 1 shows an embodiment of a health management system comprising a healthcare system and a homecare system;

FIG. 2 is a screenshot of software of the healthcare and homecare systems of FIG. 1;

FIG. 3 is a help screen associated with the screen shown in FIG. 2;

FIG. 4 is a first view of a navigation frame of the help screen of FIG. 3;

FIG. 5 is a second view of the navigation frame of FIG. 4;

FIG. 6 is a third view of the navigation frame of FIGS. 4 & 5.

Corresponding reference characters indicate corresponding parts throughout the several views. Although the drawings represent embodiments of various features and components according to the present invention, the drawings are not necessarily to scale and certain features may be exaggerated in order to better illustrate and explain the present invention. The exemplification set out herein illustrates embodiments of the invention, and such exemplifications are not to be construed as limiting the scope of the invention in any manner.

### DETAILED DESCRIPTION OF EMBODIMENTS OF THE INVENTION

For the purposes of promoting an understanding of the principles of the disclosure, reference will now be made to the embodiments illustrated in the drawings, which are described below. The embodiments disclosed below are not intended to be exhaustive or limit the disclosure to the precise form disclosed in the following detailed description. Rather, the embodiments are chosen and described so that others skilled in the art may utilize their teachings. It will be understood that no limitation of the scope of the invention is thereby intended. The disclosure includes any alterations and further modifications in the illustrated devices and described methods and further applications of the principles of the disclosure which would normally occur to one skilled in the art to which the disclosure relates.

The invention is described herein with reference to healthcare data management software, and more particularly, with reference to diabetes management software, although the invention may be applied, generally, to data management systems in fields unrelated to healthcare management.

The terms “network,” “local area network,” “LAN,” “wide area network,” or “WAN” mean two or more computers which are connected in such a manner that messages may be transmitted between the computers. In such computer networks, typically one or more computers operate as a “server”, a computer with large storage devices such as hard disk drives and communication hardware to operate peripheral devices such as printers or modems. Other computers, termed “workstations”, provide a user interface so that users of computer networks can access the network resources, such as shared data files, common peripheral devices, and inter-workstation communication. The computers have at least one processor for executing machine instructions, and memory for storing instructions and other information. Many combinations of processing circuitry and information storing equipment are known by those of ordinary skill in these arts. A processor may be a microprocessor, a digital signal processor (“DSP”), a central processing unit (“CPU”), or other circuit or equivalent capable of interpreting instructions or performing logical actions on information. Memory includes both volatile and non-volatile memory, including temporary and cache, in electronic, magnetic, optical, printed, or other format used to store information. Users activate computer programs or network resources to create “processes” which include both the general operation of the computer program along with specific operating characteristics determined by input variables and its environment.

Concepts described below may be further explained in one of more of the co-filed patent applications entitled METHOD AND SYSTEM FOR GRAPHICALLY INDICATING MULTIPLE DATA VALUES (Atty Docket: ROCHE-P0039), SYSTEM AND METHOD FOR DATABASE INTEGRITY CHECKING (Atty Docket: ROCHE-P0056), METHOD AND SYSTEM FOR DATA SOURCE AND MODIFICATION TRACKING (Atty Docket: ROCHE-P0037), PATIENT-CENTRIC HEALTHCARE INFORMATION MAINTENANCE (Atty Docket: ROCHE-P0043), EXPORT FILE FORMAT WITH MANIFEST FOR ENHANCED DATA TRANSFER (Atty Docket: ROCHE-P0044), GRAPHIC ZOOM FUNCTIONALITY FOR A CUSTOM REPORT (Atty Docket: ROCHE-P0048), METHOD AND SYSTEM FOR SELECTIVE MERGING OF PATIENT DATA (Atty Docket: ROCHE-P0065), METHOD AND SYSTEM FOR PERSONAL MEDICAL DATA DATABASE MERGING (Atty Docket: ROCHE-P0066), METHOD AND SYSTEM FOR WIRELESS DEVICE COMMUNICATION (Atty Docket: ROCHE-P0034), METHOD AND SYSTEM FOR SETTING TIME BLOCKS (Atty Docket: ROCHE-P0054), METHOD AND SYSTEM FOR ENHANCED DATA TRANSFER (Atty Docket: ROCHE-P0042), COMMON EXTENSIBLE DATA EXCHANGE FORMAT (Atty Docket: ROCHE-P0036), METHOD OF CLONING SERVER INSTALLATION TO A NETWORK CLIENT (Atty Docket: ROCHE-P0035), METHOD AND SYSTEM FOR QUERYING A DATABASE (Atty Docket: ROCHE-P0049), METHOD AND SYSTEM FOR EVENT BASED DATA COMPARISON (Atty Docket: ROCHE-P0050), DYNAMIC COMMUNICATION STACK (Atty Docket: ROCHE-P0051), SYSTEM AND METHOD FOR REPORTING MEDICAL INFORMATION (Atty Docket: ROCHE-P0045), METHOD AND SYSTEM FOR MERGING EXTENSIBLE DATA INTO A DATABASE USING GLOBALLY UNIQUE IDENTIFIERS (Atty Docket: ROCHE-P0052), METHOD AND SYSTEM FOR ACTIVATING FEATURES AND FUNCTIONS OF A CONSOLIDATED SOFTWARE APPLICATION (Atty Docket: ROCHE-P0057), METHOD AND SYSTEM FOR CONFIGURING A CONSOLIDATED SOFTWARE APPLICATION (Atty Docket: ROCHE-P0058), METHOD AND SYSTEM FOR DATA SELECTION AND DISPLAY (Atty Docket: ROCHE-P0011), METHOD AND SYSTEM FOR ASSOCIATING DATABASE CONTENT FOR SECURITY ENHANCEMENT (Atty Docket: ROCHE-P0041), METHOD AND SYSTEM FOR CREATING REPORTS (Atty Docket: ROCHE-P0046), METHOD AND SYSTEM FOR CREATING USER-DEFINED OUTPUTS (Atty Docket: ROCHE-P0047), DATA DRIVEN COMMUNICATION PROTOCOL GRAMMAR (Atty Docket: ROCHE-P0055), HEALTHCARE MANAGEMENT SYSTEM HAVING IMPROVED PRINTING OF DISPLAY SCREEN INFORMATION (Atty Docket: ROCHE-P0031), and METHOD AND SYSTEM FOR MULTI-DEVICE COMMUNICATION (Atty Docket: ROCHE-P0064), the entire disclosures of which are hereby expressly incorporated herein by reference. It should be understood that the concepts described below may relate to diabetes management software systems for tracking and analyzing health data, such as, for example, the Accu-Chek® 360° product provided by Roche Diagnostics. However, the concepts described herein may also have applicability to apparatuses, methods, systems, and software in fields that are unrelated to healthcare. Furthermore, it should be understood that references in this patent application to devices, meters, monitors, pumps, or related terms are intended to encompass any currently existing or later developed apparatus that includes some or all of the features attributed to the referred to apparatus, including but not limited to the Accu-Chek® Active, Accu-Chek® Aviva, Accu-Chek® Compact, Accu-Chek® Compact Plus, Accu-Chek® Integra, Accu-Chek® Go, Accu-Chek® Performa, Accu-Chek® Spirit, Accu-Chek® D-Tron Plus, and Accu-Chek® Voicemate Plus, all provided by Roche Diagnostics or divisions thereof.

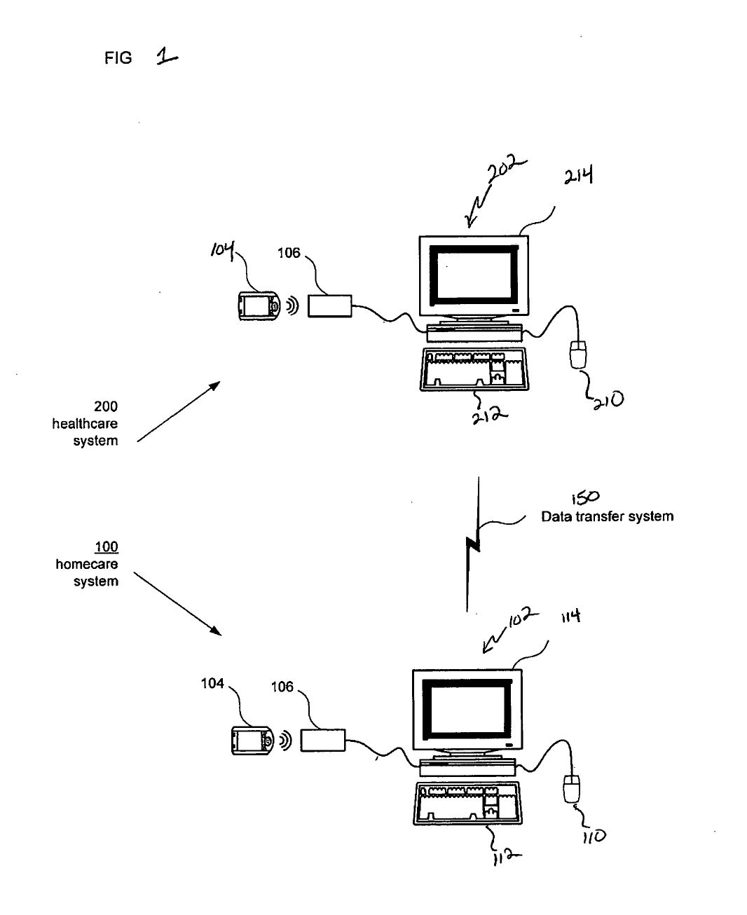

Turning now to the figures, FIG. 1 depicts an exemplary embodiment of a homecare system 100 and healthcare system 200 connected via a WAN 150 for monitoring data. Systems 100, 200 each comprise a computing device, shown here in the form of computers 102, 202 having processing units, system memory, display devices 114, 214, and input devices 112, 212, 110, 210, 106. Healthcare computer 202 may be, but is not necessarily, acting as a server. Furthermore, while only two computers 102, 202 are shown, many more computers may be part of the overall system. Additionally, computers 102, 202 of systems 100, 200 may be substituted by a PDA, pump, cell phone, or a device with data storage capabilities.

While standard input devices such as mice 110, 210 and keyboards 112, 212 are shown, systems 100, 200 may comprise any user input device. By example, infrared (IR) dongles 106 are coupled to each of computers 102, 202. IR dongles 106 are configured to send and receive IR transmissions from meters 104. Computers 102, 202 include software applications configured to receive data from meters 104 via IR dongles 106 or otherwise. While the use of IR and IR dongles is disclosed herein for the transmission of data between health management device 104 and computers 102, 202, any other method of data transmission is also envisioned, including but not limited to: direct cable link, RF or other wireless transmissions, and input of the data via keyboards 112, 212. Systems 100, 200 include health management software 300 configured to receive medical information from one or more of input devices 112, 212, 110, 210, 106.

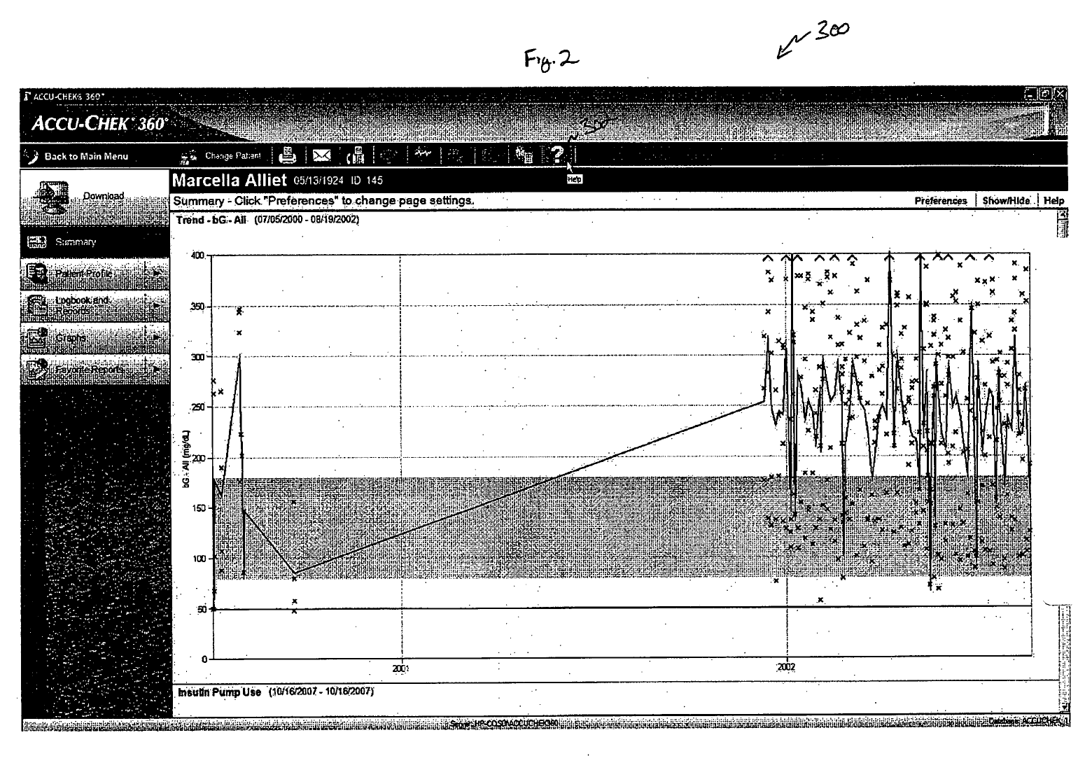

Health management software 300, an embodiment of which is shown via a screenshot in FIG. 2, comprises one or more programs configured to receive, organize, and use patient medical information. Health management software 300 comprises a database for storing, retrieving, organizing, displaying, and, generally, for managing patient medical information. In this context, the term “patient” refers to a person whose medical information is stored in the health management software. Patient medical information comprises administrative data and medical data. Patient administrative data comprises non-medical data related to the identification of patients (“patient identity data”) and administration of patients and patient records (“patient non-identity data”). Patient identity data includes name, address, phone number, etc. Patient non-identity data includes information pertaining to insurance providers, etc. Patient medical data, or medical data, means qualitative and quantitative data relating to a patient state such as, for example, test results, laboratory values, measurements, observations, treatment or dosage values, or prescriptions. Medical data may be provided by the patient, a healthcare professional, a healthcare device, a caregiver, or anyone having relevant data pertaining to a patient.

Systems 100, 200 may be used by the patient, a healthcare professional, a caregiver, or anyone having or needing relevant data pertaining to a patient. Systems 100, 200 may be located in a patient's home, a healthcare facility, or any other convenient place. In the provided embodiment, two systems 100, 200 are connected and medical data is transferred between them. As shown, homecare system 100 is located in a place accessible to the patient, and the healthcare system 200 is located in a healthcare facility. In this embodiment, the first and second systems are configured to transfer medical data between them by any means known in the art such as, for example, via the Internet (WAN 150), cellular communications, or the physical transfer of a memory device such as a diskette, USB key, or compact disc. The homecare system 100 may be configured to receive medical data from health management device 104. Healthcare system 200 is also configured to receive medical data from health management device 104 or, alternatively, to receive medical data transferred from homecare system 100. Healthcare system 200 can receive medical data from a plurality of homecare systems 100.

Health management software 300 is configured to show and store medical data in a plurality of forms and formats. Medical data may be shown on display devices 114, 214 or a printed report in record, graphic, or tabular format. The first step for the software user is to obtain medical data from the medical device, such as an insulin pump or glucose meter. Typically, the user collects medical data from health management device 104 periodically, and computer 102, 202 maintains a database of the accumulated medical data. Often, such medical data includes information covering both the dosages (e.g., when health management device 104 is an insulin pump) and the patient measurements (e.g., when health management device 104 is a glucose meter).

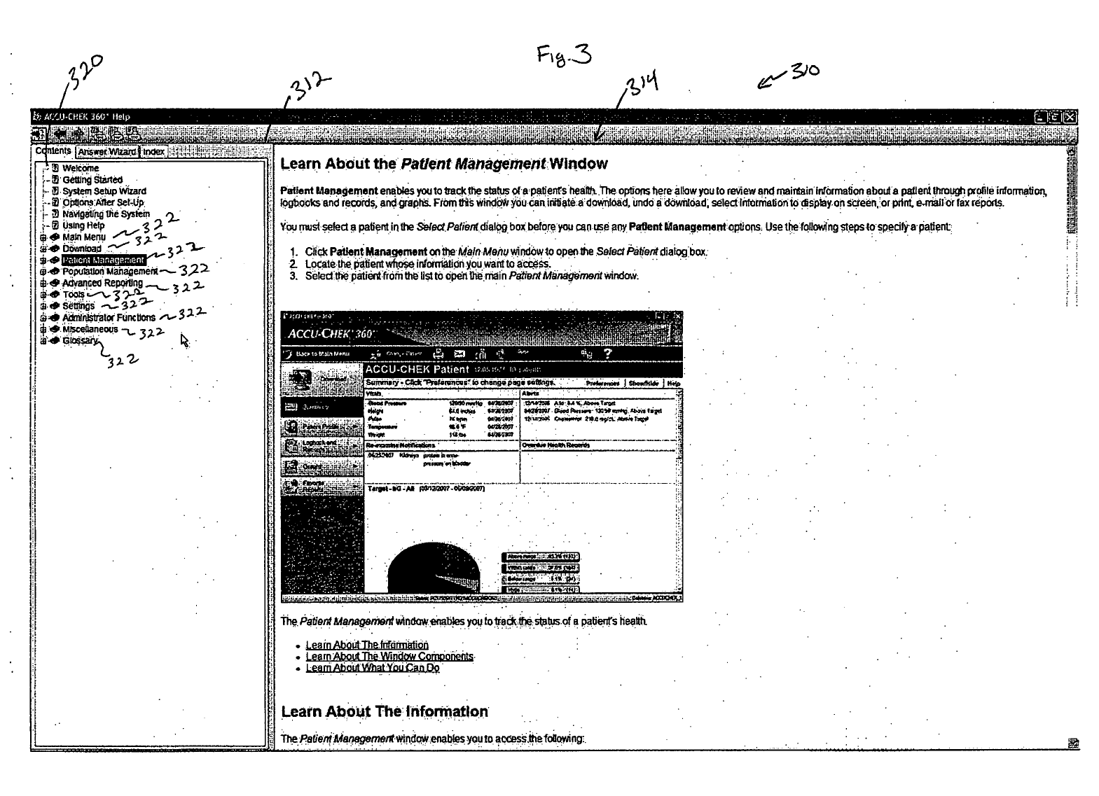

Once collected, the data can be manipulated by software 300 in a plurality of ways to generate reports or provide other functionalities. One such report displays the bG measurements for a particular patient, as shown in FIG. 2. During use of this, or any other, screen and functionality of software 300, the user may need help in gaining understanding as to the workings of software 300 or in interpreting the screen being viewed. Accordingly, a help module 310, FIG. 3, is present within software 300.

Each screen of software 300 includes a question mark icon 302. Hovering the cursor over icon 302, otherwise referred to as a “mouse-over,” provides a text box that indicates that icon 302 is a help icon, as shown in FIG. 2. Help module 310 is accessed by clicking on icon 302.

Help module 310 includes two panes or frames 312, 314. Frames 312, 314 are generally referred to as navigation frame 312, and information frame 314. Navigation frame 312 includes navigation tree 320 that shows help functionalities for all installed and activated features. A more detailed explanation of functionalities being installed, activated, and shown is described in the co-filed and co-owned applications previously incorporated by reference.

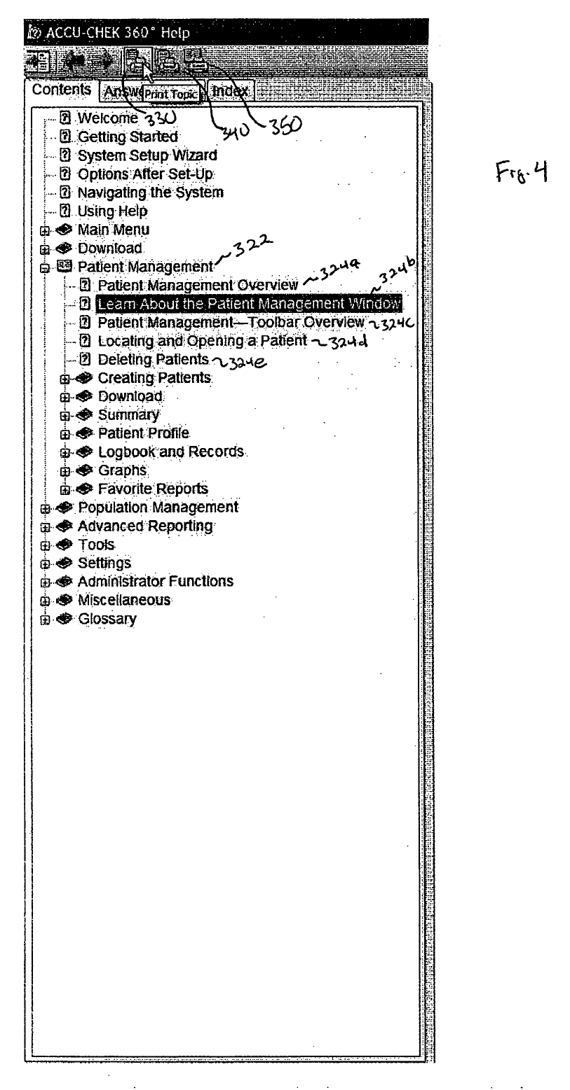

Installing and activating features affect which topics are available for viewing within navigation tree 320. The availability of some features and topics is determined by the particular installation of the software purchased, which can be implemented by activation key. The availability of some features and topics is also determined by whether such features are chosen to be enabled or disabled during the installation process. Administrators may wish to have differing activations than healthcare or homecare users. Usage patterns by users may lead to different users desiring to have unused or unwanted features hidden from view to thereby simplify the interface. Users are therefore able to show/hide screens and features to customize their interface with the software. Such show/hide decisions do not affect which help topics are displayed. However, embodiments are envisioned where such show/hide decisions do impact which help topics are displayed. Navigation tree 320 allows selective expansion of features 322 to show what topics 324a-e, FIG. 4, are available within the selected feature 322 according to the installation, and activation status thereof. Generally speaking, navigation tree 320 provides a nested hierarchy of document-feature 322-topic 324. This hierarchy is also referred to herein as book-chapter-page. Each of the terms “document”, “feature”, “topic”, “book”, “chapter”, and “page” are generally referred to as levels. In the provided examples, the terms are only used to denote a relative hierarchy where “document” and “book” denote the highest order levels, “topic” and “page” denote the lowest order levels, and “feature” and “chapter” denote intermediate order levels. Higher order levels contain one or more lower order levels. While navigation tree 320 is discussed as having three levels, it should be appreciated that trees having greater and fewer levels are contemplated.

Each help file or page/topic 324 is embodied in an XML file. The XML file includes a plurality of fields that provide information regarding the treatment and content of the topic 324. Each XML file includes header information that indicates which feature 322 the particular topic 324 is related to. Further headers within each XML file include terms to be placed in the help index to refer to the topic, terms that should be placed in an answer wizard to refer to the topic, as well as the actual help text and references to any images that are to be incorporated into the topic when displayed. Navigation tree 320 is created by reading all the help files and assembling the topics under the features 322 to which they refer. Alternatively, navigation tree 320 is created from a manually created map file that lists all topic files that are desired to be included. In such embodiments, feature 322 references within topic files 324 are used to filter and alter the display of topic files 324 in accordance with the activation and enable decisions.

A listing of index terms and a listing of answer wizard terms is assembled and saved as a file that can be quickly referred to by help module 310. Thereby, a cache copy of the topic tags for index terms and answer wizard terms is created so that the files need not be scanned for each use of the index or answer wizard. Content changes, topic associations, and index and answer wizard terms for the topics can be changed by the programmers and sent down as updates to users. Likewise, the associations of topics to features can be changed and sent to users. Such changes in association alter the filters that are applied to determine which help topics 324 are enabled/disabled in response to a enable/disable decision of the related functionality. Such changes do not require re-compiling of help module 310 in that the changes are only to the underlying data files and not the executable files.

Upon activation, help module 310 displays a help page that is relevant to the last viewed portion of software 300 (i.e., the initially displayed page is context sensitive). FIG. 2 shows a patient management window. Accordingly, selecting help via icon 302 engages help module 310 that defaults to first showing a help page relevant to the patient management window as shown in FIG. 3. Once within help, the user can navigate, via frame 312, to other help subjects. Selecting another topic 324a-e causes that topic to be displayed in information frame 314.

If hardcopies of the help information are desired, three printing options are provided to the user. As shown in FIG. 4, each option is presented as an icon 330, 340, 350 or other selectable indicia, such as a dropdown list or otherwise, in help module 310. The three printing options are to “print topic” icon 330, “print feature” icon 340, and “print user guide” icon 350.

For any topic displayed in information frame 314, selection of print topic icon 330 results in printing of the information currently displayed in frame 314. A mouse-over of icon 330 indicates that icon 330 is provided to “Print Topic,” as shown in FIG. 4. This printing occurs regardless of whether or not a particular topic has been selected via navigation frame 312. In instances where a particular topic has not been selected via navigation frame 312, the default topic displayed that relates to the screen in software 300 from which help was activated is printed.

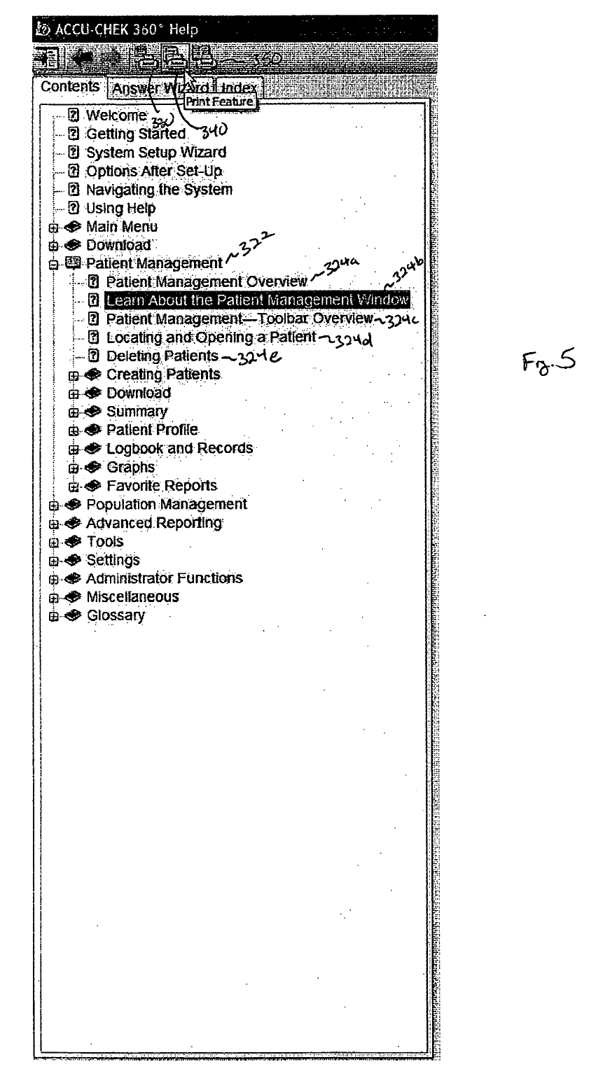

Selection of icon 340 results in printing of all topics 324a-e that are under the same feature 322 as the topic 324b currently displayed in information frame 314. A mouse-over of icon 340 indicates that icon 340 is provided to “Print Feature,” as shown in FIG. 5. Again, the printing of the entire feature occurs regardless of whether a particular topic or feature has been selected via navigation frame 312. In instances where a particular topic or feature has not been selected via navigation frame 312, the feature 322 including the default topic 324b that relates to the screen in software 300 from which help was activated is printed.

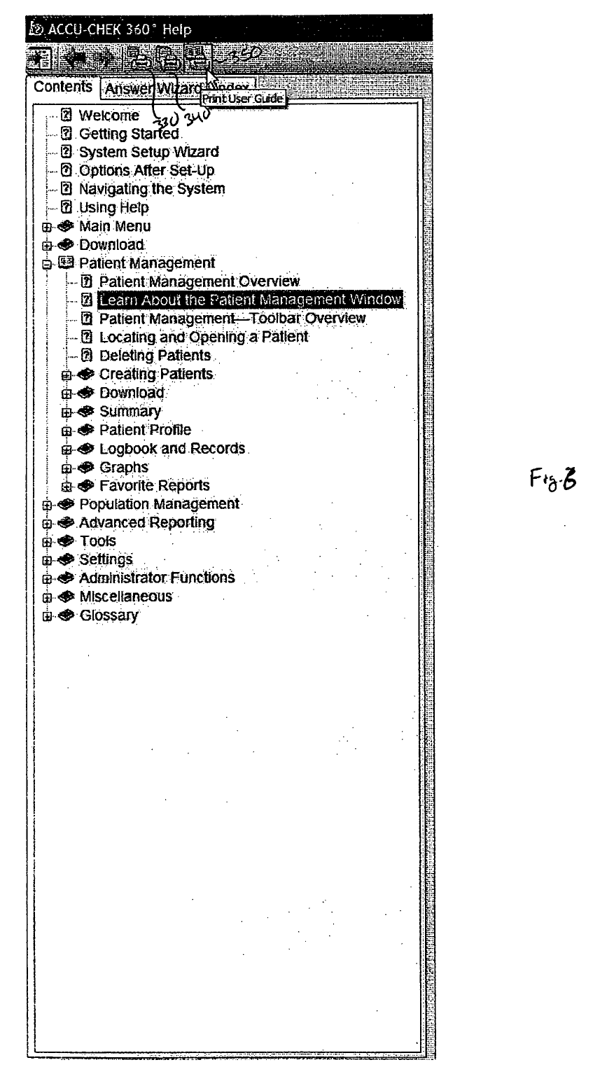

Selection of icon 350 results in printing of the entire user guide. A mouse-over of icon 350 indicates that icon 350 is provided to “Print User Guide,” as shown in FIG. 6. Accordingly, a user is able to choose an appropriate order level of the help manual to print with a single click.

The navigation tree 320 of navigation frame 312 only provides options to display help related to features that are installed and activated. Any features chosen to be disabled rather than enabled and their respective topics do not appear as selectable options within the tree.

Any feature not installed or not activated is not shown in tree 320 nor available to be printed. Thus, selecting “Print Feature” 340 or “Print User Guide” 350 only prints features and topics that are installed and activated.

However, “Print Feature” 340 prints the installed and activated topics relating to that feature regardless of their status as enabled/disabled. Accordingly, a printed help document for a chosen feature will be consistently produced, regardless of the particular enable/disable choices made by a user.

Similarly, “Print User Guide” 350 prints the installed features and topics regardless of their activation status and regardless of their status as enabled/disabled. Accordingly, a printed user guide will be consistently produced by any system 100, 200 having common installation (activation key) regardless of the activated features on a particular installation and regardless of the particular enable/disable choices made by a user.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A computer readable medium, including instructions thereon such that when interpreted by a processor cause the processor to perform the steps of:
receiving medical data from a health management device;
displaying a multi-level help tree, the help tree having help information relating to medical data processing functionality; the help tree segmenting the help information into a plurality of selectable chapters, each chapter including at least one displayable help page;
displaying a first icon that, when selected, issues instructions to print the displayed help page;
displaying a second icon that, when selected, issues instructions to print all help pages within the same chapter as the displayed page; and
displaying a third icon that, when selected, issues instructions to print all available help pages.

2. The computer readable medium of claim 1, wherein the first, second, and third icons are simultaneously displayed to a user.

3. A computer readable medium, including instructions thereon such that when interpreted by a processor cause the processor to perform the steps of:
displaying a first icon that, when selected, issues instructions to produce a document including first help information relating to a displayed page; and
displaying a second icon that, when selected, issues instructions to produce a document including second help information relating to a chapter that includes the displayed page.

4. The computer readable medium of claim 3, wherein the second icon, when selected, issues instructions to produce a document including second help information contained in a plurality of pages, including the displayed page.

5. The computer readable medium of claim 3, further causing the processor to display a third icon that, when selected, issues instructions to produce a document including third help information relating to a plurality of chapters.

6. The computer readable medium of claim 5, wherein the plurality of chapters include all help pages that have been installed.

7. The computer readable medium of claim 3, wherein the instructions to produce a document including first help information and the instructions to produce a document including second help information are instructions to create print copies of the first and second help information, respectively.

8. The computer readable medium of claim 3, further including instructions that cause the processor to display a multi-level help tree and the second help information includes help pages not shown in the help tree.

9. The computer readable medium of claim 3, further including instructions that cause the processor to display a multi-level help tree containing at least one chapter and the at least one chapter including therein at least one page of help information.

10. The computer readable medium of claim 9, wherein the second help information includes all pages of help information within the at least one chapter that includes the displayed page.

11. The computer readable medium of claim 3, wherein the first and second icons are displayed at the same time.

12. A computer readable medium, including instructions thereon such that when interpreted by a processor cause the processor to perform the steps of:
displaying a first selectable indicia that, when selected, issues instructions to produce a document including first help information relating to a first page; and
displaying a second selectable indicia that, when selected, issues instructions to produce a document including second help information relating to a chapter that includes the first page.

13. The computer readable medium of claim 12, wherein the first page is a page displayed to a user at the time of selection of the first or second indicia.

14. The computer readable medium of claim 13, further including instructions that cause the processor to permit a user to enable/disable one or more pages, the document including second help information including all pages relating to the chapter that includes the first page regardless of the user selection to enable/disable any of the pages within the chapter.

15. The computer readable medium of claim 12, further including instructions that cause the processor to display a third selectable indicia that, when selected, issues instructions to produce a document including third help information including all available pages.

16. The computer readable medium of claim 12, wherein the instructions to produce a document including first help information and the instructions to produce a document including second help information are instructions to create print copies of the first and second help information, respectively.

17. The computer readable medium of claim 12, further including instructions that cause the processor to display an expandable help tree containing at least one chapter and the at least one chapter including therein at least one page of help information.

18. The computer readable medium of claim 12, wherein the second selectable indicia, when selected, issues an instruction to produce a document including second help information containing a plurality of pages, including the first page.

19. The computer readable medium of claim 12, further including instructions that cause the processor to display the first and second selectable indicia simultaneously.

20. The computer readable medium of claim 12, further including instructions that cause the processor to display informational text upon a mouse-over of either of the first and second selectable indicia.

21. A computer readable medium, including instructions thereon such that when interpreted by a processor cause the processor to perform the steps of:
reading a plurality of files, each file pertaining to a topic and having organizational data and displayable data therein;
determining whether each piece of displayable data is to be accessible to a user according to the organizational data and installation choices; and
displaying the displayable data of at least one of the plurality of files.

22. The computer readable medium of claim 21, wherein the displayable data is help information.

23. The computer readable medium of claim 21, wherein the files are XML files.

24. The computer readable medium of claim 23, wherein organizational data includes the name of a group to which the displayable data is to be associated.

25. The computer readable medium of claim 21, wherein the processor is further caused to perform the step of creating a hierarchical help tree that organizes the displayable data.

26. The computer readable medium of claim 25, wherein the associations are changeable within the tree by altering the organizational data.

27. The computer readable medium of claim 26, wherein changes to associations may be effected without recompiling the instructions.

28. The computer readable medium of claim 21, wherein each file further includes data relating to index words associated with the file and data relating to answer wizard language associated with the file.

29. The computer readable medium of claim 28, wherein the instructions further cause the processor to perform the steps of:
reading the index words from each of the files; and
creating a index file containing each of the index words and their topic associations.
